(19) United States
(12) Patent Application Publication
(10) Pub. No.: US 2023/0220805 A1
(43) Pub. Date: Jul. 13, 2023

(54) AN ELECTRO-MECHANICAL ACTUATION CONTROL SYSTEM AND A METHOD TO CONTROL THE SYSTEM THEREOF

(71) Applicant: TVS MOTOR COMPANY LIMITED, Chennai (IN)

(72) Inventors: Mohan Barath, Chennai (IN); Velagapudi Sai Praveen, Chennai (IN); Chandrashekara Kp, Chennai (IN)

(73) Assignee: TVS MOTOR COMPANY LIMITED, Chennai (IN)

(21) Appl. No.: 18/010,951

(22) PCT Filed: Jul. 20, 2021
(86) PCT No.: PCT/IN2021/050705

§ 371 Date: Dec. 16, 2022

(30) Foreign Application Priority Data
Jul. 24, 2020 (IN) 202041031856

(51) Int. Cl. F02D 11/10; B60W 10/04; B60W 10/18; B60W 30/14; B60W 50/023

(52) U.S. Cl. CPC F02D 11/107; B60W 10/04; B60W 10/18; B60W 30/143; B60W 50/023; F02D 11/106; B60W 2300/36; B60W 2510/0604; B60W 2510/081; F02D 2200/501

(57) ABSTRACT

An electro-mechanical actuation control system includes: a comparator configured to compare a desired vehicular component data to an actual vehicular component data; a controller that is configured to enable control of vehicular components and includes vehicle component controllers; a transmitter configured to remotely transmit input signals to the vehicle; a receiver configured to receive the transmitted input signals from the controller and mounted on the vehicle; an actuator driver configured to receive inputs from the receiver and mounted on the vehicle; an actuator coupled to the actuator driver and configured to be operable in any one of an enabled state and a disabled state caused by the actuator driver; and one or more vehicle components that comprise a drive unit including one of an engine assembly, an electric motor and a combination of the engine assembly and the electric motor.

### TECHNICAL FIELD

The present subject matter relates to vehicle. More particularly but not exclusively, to an electro-mechanical actuation control system and a method to control the electro-mechanical actuation control system thereof for controlling the speed of the vehicle.

### BACKGROUND

Generally, vehicles like two or three wheeled type vehicles are provided with an internal combustion (IC) engine unit for driving and some motor vehicles and are provided with electric motors for driving electric vehicles. These vehicles may constitute two-wheels or three-wheels depending on application, engine layout etc. Some of these vehicles are provided with a swinging-type engine, and a connecting link, like a toggle link, is provided to support the IC engine unit. The inputs to the engine are provided according to the throttle requirement in the vehicle. Speed control in vehicles is one of the primary requirements. A throttle position sensor (TPS) is used to sense the position of the throttle opening. The TPS is connected through a wire to a carburetor or to a fuel injector depending upon the application. In case of an electric vehicle, the TPS is connected through a wire to an electric motor.

### BRIEF DESCRIPTION OF THE DRAWINGS

The detailed description is described with reference to an embodiment of a scooter type saddle vehicle along with the accompanying figures. The same numbers are used throughout the drawings to reference like features and components.

FIG. 1 depicts a side view of an exemplary two-wheeled vehicle, in accordance with an embodiment of the present subject matter.

FIG. 2 illustrates a schematic diagram of an electro-mechanical actuation system according to an aspect of the present subject-matter.

FIG. 3 illustrates a schematic diagram of an electro-mechanical throttle valve actuator control system according to a first embodiment of the present subject-matter.

FIG. 4 illustrates an electro-mechanical brake control actuator control system according to a second embodiment of the present subject-matter.

FIG. 5 illustrates a flow diagram for a method to control the electro-mechanical actuator system according to an aspect of the present invention.

FIG. 6 illustrates a flow diagram for a method to control the actuation of electro-mechanical system through one or more vehicular components.

FIG. 7 illustrates a flow diagram for a fail-safe control method for actuation of an electro-mechanical control system.

FIG. 8 illustrates a flow diagram for a fail-safe control method for actuation of an electro-mechanical control system according to a first embodiment of the present subject matter.

FIG. 9 illustrates a flow diagram for a fail-safe control method for actuation of an electro-mechanical control system according to a second embodiment of the present subject matter.

### DETAILED DESCRIPTION OF THE INVENTION

Speed control in the vehicles is generally provided by using a throttle position switch, an electronic control unit and a fuel injector. Based on the position of the throttle, the electronic control unit controls the speed of the motorcycle. These existing systems are expensive and are not cost effective.

In the existing systems, where the rider is operating the throttle, a cable is required to transmit the throttle position to a vehicle component, for example, a throttle valve, a fuel injector or a motor to produce required torque. Generally, a mechanical cable or a mechanical wire is used to transmit the throttle position. The mechanical wires or cables are not reliable as they are prone to breakage and damages. Further, the signals transmitted through mechanical wires are prone to losses, backlash and hence may not be able to achieve accurate and instantaneous results. The systems using mechanical cables are prone to produce delayed responses. The delayed responses are not preferred in today's fast pacing world. The mechanical cables have to be carefully routed through the vehicle, else, that would lead to clumsy look, degrading the aesthetic appeal of the vehicle. Furthermore, the mechanical wires tend to interfere with steering system by not allowing smooth steering of the vehicle.

Therefore, there exists a need for a simple and quick response system to accurately as well as precisely control the speed of the vehicle as desired to overcome all the above described limitations and other problems of known art.

The present-subject matter provides an electro-mechanical actuation control system and a method to control the system thereof. The electro-mechanical actuation control system for the vehicle includes a controller module, a controller knob, a transmitter, a receiver, an actuation driver, an actuator, one or more vehicle components and one or more auxiliary power sources.

The controller module is configured to enable speed control of said vehicle. The controller module includes one or more vehicle component controller. The controller knob is present along with the controller. The control know can be a switch that can be operable in ON and OFF state. The transmitter is configured to transmit input signals as generated by the controller module to a receiver. The receiver is configured to receive transmitted input signals from the transmitter. The receiver passes the received inputs to the actuator driver. The actuator driver is mounted on the vehicle. The actuator is connected to the actuator driver. The actuator is configured to be in any one of enabled state and disabled state caused by said actuator driver. In the enabled state, the actuator driver is controlling the working of the one or more vehicle components. Whereas, in the disabled state, actuator driver does not control the working of the one or more vehicle components. The one or more vehicle components are connected to said actuator.

According to the present subject-matter, the one or more vehicle components can be remotely controlled. That is the mechanical connection between the one or more vehicular components and the knob/switch in the vehicle is eliminated. Instead, only a single mechanical control is present between the actuator driver and the one or more vehicle components. The actuator driver is remotely controlled and instantaneous inputs are provided to the one or more vehicular components. The one or more vehicular components act according to the required inputs and provide quick response.

In an embodiment, the actuator driver is a direct current servo motor. The actuator driver is being remotely operated through the transmitter. The actuator driver operates a carburetor in an engine assembly using carburetor for providing air-fuel inputs. The actuator driver operates opening and closing of the fuel injector in an engine assembly using fuel injectors. In case of an electric vehicle, the throttle position sensor is configured to sense the amount of throttle opening and this input is provided to the controller module. The controller module is configured to determine the amount of torque that is to be generated by an electric motor to drive the vehicle. These inputs will be provided as inputs to the electric motor from the controller. In an embodiment, the inputs about the throttle opening requirement can be remotely provided to the actuator driver. Further, these inputs are transmitted from the actuator driver to the electric motor. By using servo motors and mechanical cables, which can be integrated to the one or more vehicle components, the speed of the vehicle can be controlled.

In another embodiment, for an autonomous vehicle, the throttle can be remotely operated based on the requirement. The system as described above holds good to control the speed of a conventional as well as an autonomous vehicle.

Further, an auxiliary power source 1 is used to provide power supply to the controller module. An auxiliary power source 2 is used to provide power supply to the receiver.

According to another embodiment of the present invention, the system can be used in parallel to the conventional mechanical wired system as a fail-safe electro-mechanical actuation control system. In case the mechanical wire breaks, the rider will be able to control the speed of the vehicle with the help of the electromechanical actuator control system.

In an embodiment, to achieve the above said system, a throttle position switch is integrated with the throttle valve, which communicates with the servo motor electronically through a controller.

In particular scenario, whenever, the throttle cable fails, the proposed fail-safe system comes into action. In case of failure of the physical cable, the controller module is indicated about the failure of the mechanical cable, and the controller module is configured to receive inputs from the TPS. These inputs are remotely transmitted to the servo motor. The servo motor enables the working of the throttle valve.

The same system is applicable in case of a brake wire failure. The same fail-safe mechanism can be used to actuate the brakes of the vehicle remotely through the servo motor, the transmitter integrated with the controller module and the receiver mounted in the vehicle.

The summary provided above explains the basic features of the invention and does not limit the scope of the invention. The nature and further characteristic features of the present invention will be made clearer from the following descriptions made with reference to the accompanying drawings. The present subject matter is further described with reference to the accompanying figures. It should be noted that description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

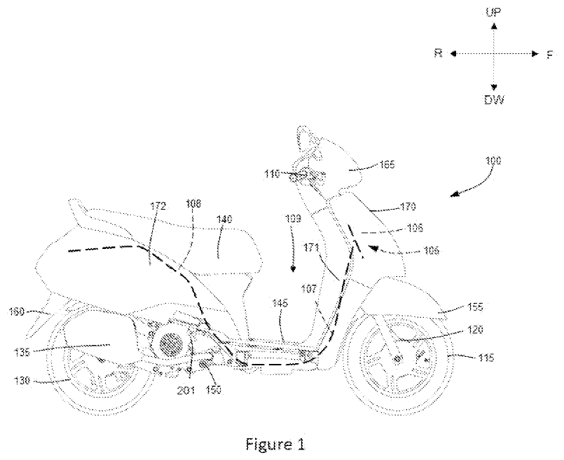

FIG. 1 depicts a side view of an exemplary two-wheeled vehicle (100), in accordance with an embodiment of the present subject matter. The vehicle (100) has a frame assembly (105) (schematically shown with dotted lines) that includes a head tube (106), a main frame (107) extending rearwardly downward from the head tube 106. The main frame (107) may comprise one or more main tube(s), and a pair of rear tubes (108) extending inclinedly rearward from a rear portion of the main tube. In the present embodiment, the vehicle (100) includes a step-through portion (109) defined by the frame assembly (105) of the vehicle (100). However, the aspects of the present subject matter are not limited to the depicted layout of the vehicle (100).

Further, a handlebar assembly (110) is connected to a front wheel (115) through one or more front suspension(s) (120). A steering shaft (not shown) connects the handlebar assembly (110) to the front suspension(s) (120) and the steering shaft is rotatably journaled about the head tube (106). An internal combustion (IC) (201) is mounted to the frame assembly (105). The engine (201) may also include a traction motor either hub mounted or mounted adjacent to the IC engine. In the depicted embodiment, the engine (201) is disposed below at least a portion of the rear frame(s) (108). However, in an alternative embodiment, the power unit may be fixedly disposed towards front and below the main tube (107). The engine (201) is functionally connected to a rear wheel (130) through a transmission system (not shown). The vehicle may include one or more rear wheel(s). Also, the vehicle (100) includes an exhaust system that helps in dissipation of exhaust gasses from the IC engine (201). The exhaust system (200) includes a muffler (135) mounted to the vehicle (100). In the depicted embodiment, the muffler (135) is disposed towards one lateral side of the vehicle (100).

Further, the rear wheel (130) is connected to the frame member (105) through one or more rear suspension(s) (not shown). In the depicted embodiment, the engine (201) is swingably mounted to the frame member (105) through a toggle link (150) or the like. A seat assembly (140) is supported by the frame assembly (105) and is disposed rearward to the step-through portion (109).

Further, the vehicle (100) includes a front fender (155) covering at least a portion of the front wheel (115). In the present embodiment, a floorboard (145) is disposed at a step-through portion (109) and is supported by the main frame (107) and a pair of floor frames (not shown). The user can operate the vehicle (100) by resting feet on the floorboard (145), in a sitting position. In an embodiment, a fuel tank (not shown) is disposed below the seat assembly (140) and behind the utility box. A rear fender (160) is covering at least a portion of the rear wheel (135). The vehicle (100) comprises of plurality of electrical/electronic components including a headlight (165), a tail light (not shown), a battery (not shown), a transistor-controlled ignition (TCI) unit (not shown), an alternator (not shown), a starter motor (not shown). Further, the vehicle (100) may include a synchronous braking system, an anti-lock braking system.

The vehicle (100) comprises plurality of panels that include a front panel 170 disposed in an anterior portion of the head tube (106), a leg-shield (171) disposed in a posterior portion of the head tube (106). A rear panel assembly (172) includes a right-side panel and a left side panel disposed below the seat assembly (140) and extending rearward from a rear portion of the floorboard (145) towards a rear portion of the vehicle (100). The rear panel assembly (172) encloses a utility box disposed below the seat assembly (140). Also, the rear panel assembly (172) partially encloses the engine (201). Also, the muffler (135) of the exhaust system is coupled to exhaust side of the IC engine and in an implementation the muffler (135) is disposed towards one lateral side of the vehicle (100).

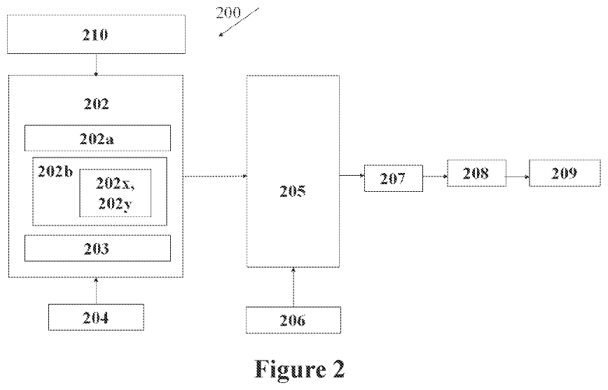

FIG. 2 illustrates a schematic diagram of an electro-mechanical actuation system according to an aspect of the present subject-matter. The electro-mechanical actuation control system (200) for the vehicle (100) includes a controller module (202) configured to enable speed control of said vehicle (100), said controller module (202) includes one or more vehicle component controller (202b). In an embodiment, the vehicle component controller (202b) includes a throttle valve controller (202x) and a vehicle brakes controller (202y). A comparator (210) communicatively connected to said controller module (202), the comparator (210) is configured to compare a desired vehicular component data with an actual vehicular component data and determine the difference between the two. A transmitter (203) configured to transmit input signals as generated by said controller module (202). A receiver (205) configured to receive transmitted input signals from said transmitter (203). An actuator driver (207) configured to receive inputs from said receiver (205), said actuator driver (207) is mounted on said vehicle (100). The actuator driver (207) is controlled by an actuator driver controller (202a). The actuator driver controller (202a) is an integrated part of the controller module (202). An actuator (208) coupled to said actuator driver (207), said actuator (208) is configured to be in any one of enabled state and disabled state caused by said actuator driver (207). One or more vehicle components (209) connected to said actuator (208 and an auxiliary power source 1 (204) to power said controller module (202) and an auxiliary power source 2 (206) to power said receiver (205).

In an embodiment, a controller knob is used to operate the controller module (202). The controller knob is a switch configured to be operable under ON and OFF conditions by providing 0 and 1 inputs.

In an embodiment, the transmitter (203) is integrated with said controller module (202).

In an embodiment, the one or more vehicle components (209) include one or more brakes (209b) and a throttle control valve (209a).

In an embodiment, the actuator driver (207) is a direct current servo motor.

In an embodiment, the actuator (208) includes a mechanical cable connected between a throttle control valve (209a) and said actuator driver (207).

According to an embodiment of the present invention, the desired vehicular component data is procured as an output from one or more sensors. For example, one or more proximity sensors.

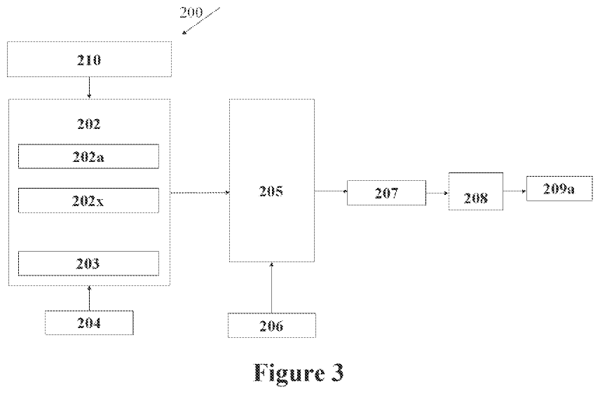

FIG. 3 illustrates a schematic diagram of an electro-mechanical throttle valve actuator control system according to a first embodiment of the present subject-matter. The electro-mechanical actuation control system (200) for controlling speed of a vehicle (100) includes the controller module (202) configured to control a throttle control valve (209a) of said vehicle (100), said controller module (202) includes throttle valve controller (202x). A comparator (210) communicatively connected to said throttle valve controller (202x). A transmitter (203) configured to transmit input signals as generated by said controller module. A receiver (205) configured to receive transmitted input signals from the controller module (202). An actuator driver (207) configured to receive inputs from said receiver (205), said actuator driver (207) is mounted on said vehicle (100). An actuator (208) is communicatively connected to said actuator driver (207), said actuator (208) is configured to be in any one of enabled state and disabled state caused by said actuator driver (207). The throttle control valve (209a) is connected to said actuator (208). The auxiliary power source 1 (204) to power said controller module (202) and an auxiliary power source 2 (206) to power said receiver (205).

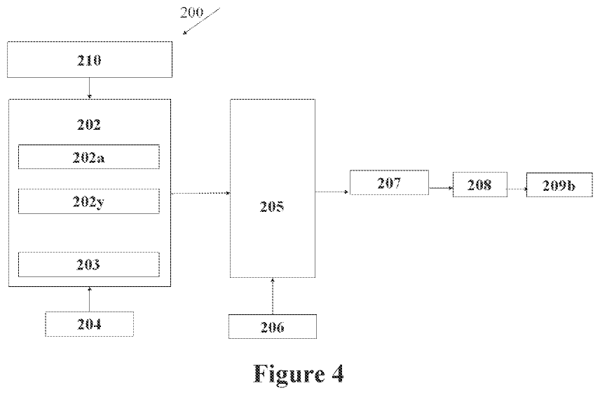

FIG. 4 illustrates an electro-mechanical brake control actuator control system according to a second embodiment of the present subject-matter. The electro-mechanical actuation control system (200) for controlling speed of a vehicle (100) includes the controller module (202) configured to control one or more brakes (209b) of said vehicle (100), said controller module (202) includes brake controller (202y). A comparator (210) communicatively connected to said brake controller (202y). A transmitter (203) configured to transmit input signals as generated by said controller module. A receiver (205) configured to receive transmitted input signals from said transmitter (203). An actuator driver (207) configured to receive inputs from said receiver (205), said actuator driver (207) is mounted on said vehicle (100). An actuator (208) communicatively connected to said actuator driver (207), said actuator (208) is configured to be in any one of enabled state and disabled state caused by said actuator driver (207). The one or more brakes (209b) is connected to said actuator (208). The auxiliary power source 1 (204) to power said controller module (202) and an auxiliary power source 2 (206) to power said receiver (205).

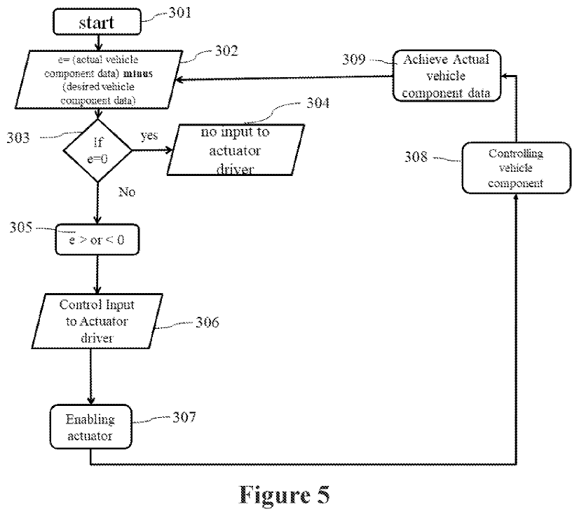

FIG. 5 illustrates a flow diagram for a method to control the electro-mechanical actuator system according to an aspect of the present invention. The method comprising the steps of initializing the control system (200) as indicated at step (301). Comparing an actual vehicle component data from the vehicle (100) with a desired vehicle component data as indicated at step (302) and determining a difference ‘e’ between actual vehicle component data and desired vehicle component data. Identifying whether the vehicle (100) is at desired vehicle component data as indicated at step (303) when there is no difference in actual vehicle component data and desired vehicle component data, which is, ‘e’=0 and at step (304), and no input is sent to an actuator driver (207). At step (305) identifying whether the vehicle (100) is at a difference vehicle component data, that is, ‘e’> or <0, which implies there is difference in desired vehicle component data and actual vehicle component data. Enabling the actuator driver (207) as indicated at step (306) by receiving inputs from a controller module (202). Enabling an actuator (208) according to inputs received from the actuator driver (207) as indicated at step (307). Controlling one or more vehicle components (209) by said actuator (307) as indicated at step (308) and achieving desired vehicle component data as indicated by step (309).

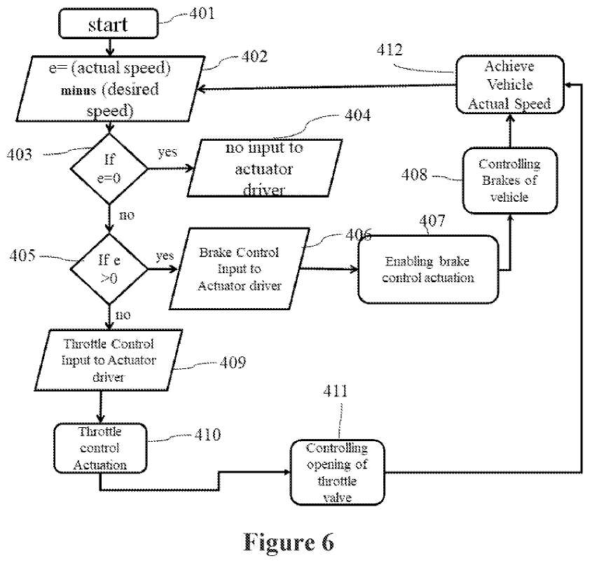

FIG. 6 illustrates a flow diagram for a method to control the actuation of electro-mechanical system through one or more vehicular components. The method includes the steps of initializing the control system (200) as indicated at step (401), comparing an actual speed data from the vehicle (100) with a desired speed data and determining a difference ‘e’ in the speed data between the actual vehicle speed data and a desired vehicle speed data as indicated at step (402), identifying at step (403), whether no input is required to be given to an actuator driver (207), when said difference in the speed data ‘e’=0 and giving no input to the actuator driver as indicated at step (404), providing brake control input to an actuator driver (207) as indicated at step (406). Further, at step 405, determining if the difference in speed data ‘e’>0, then enabling brake control input to the actuator driver at step (406) and thereby actuating of an brake actuator (208) by said actuator driver (207) as indicated at step (407), controlling of the brakes of vehicle (100) by enabling said actuator (208) as indicated at (408). Further, if at step 405, ‘e’<0, then providing throttle control input to an actuator driver (207) as indicated at step (409) thereby at step (410) enabling throttle control actuation of said actuator (208) by said actuator driver (207) and at step (411) controlling opening of throttle valve by enabling said actuator (208).

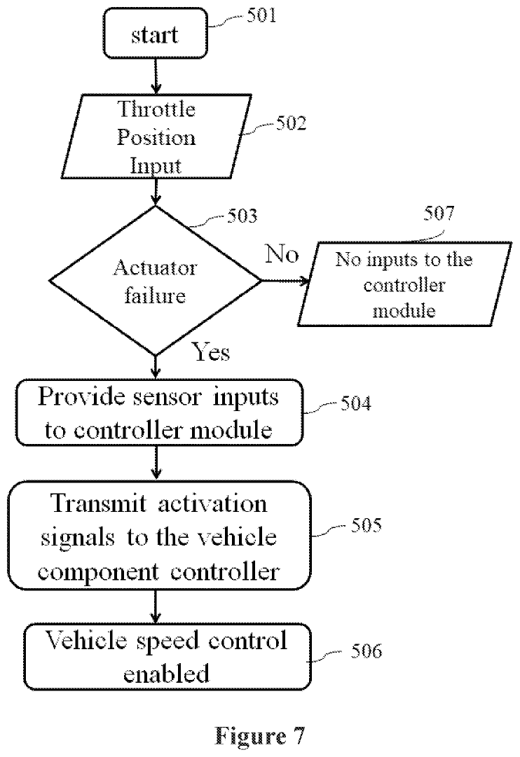

FIG. 7 illustrates a flow diagram for a fail-safe control method for actuation of an electro-mechanical control system. The method comprises the steps of, initializing the fail-safe method as indicated at (501), monitoring for throttle position input from throttle position sensor as indicated at step (502), identifying no inputs to be sent to a controller module (202) at step (507) if no failure of an actuator (208) is determined at step (503). Further, if failure of actuator is determined at step (503), then at step (504) identifying and sending a sensor inputs to said controller module (202) as indicated at step (504), further at step (505) transmitting of activation signals wirelessly to one or more vehicle component controller (202b), and at step (506) enabling vehicle speed control.

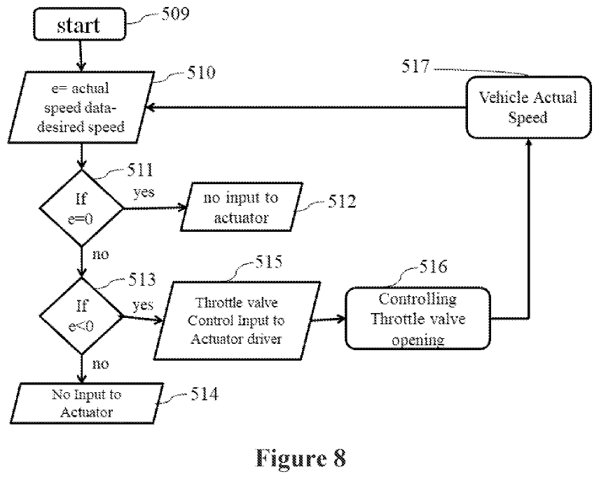

FIG. 8 illustrates a flow diagram for a fail-safe control method for actuation of an electro-mechanical control system according to a first embodiment of the present subject matter. The method comprising the steps of, initializing the fail-safe method as indicated at step (509), comparing an actual speed data to a desired speed data and determining a difference ‘e’ in said actual speed data and said desired speed data as indicated at step (510), further at step (511) identifying whether ‘e’=0 and if so, at step (512) determining no input is required for enabling an actuator (208) if said difference in said actual speed data and said desired speed data is 0. However, if at step 511, ‘e’ is not equal to 0 then at step (513), determining if ‘e’<0 and if Yes, then at step (515), providing throttle valve control input to an actuator driver (207).and at step (516) controlling throttle valve opening to control the speed of the vehicle at step (517) which is fed back to step (510). If at step (513), ‘e’>0, then at step (514), identifying no input to be sent to the actuator (208).

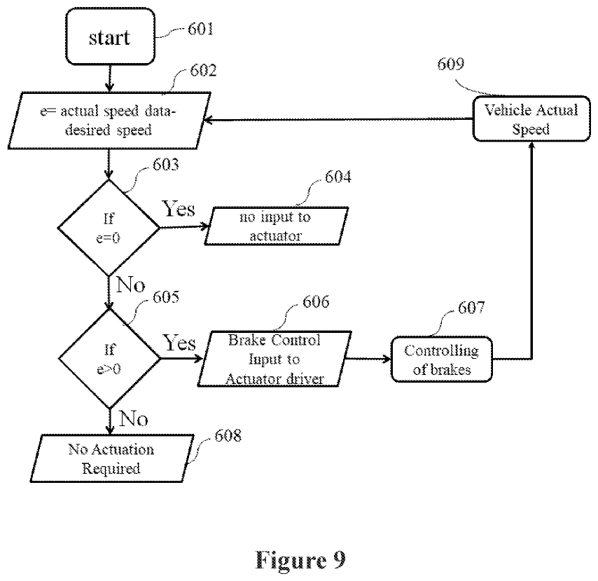

FIG. 9 illustrates a flow diagram for a fail-safe control method for actuation of an electro-mechanical control system according to a second embodiment of the present subject matter. The method comprising the steps of, initializing the fail-safe method as indicated at step (601), comparing an actual speed data to a desired speed data and determining a difference ‘e’ in said actual speed data and said desired speed data as indicated at step (602), identifying at step (603), whether ‘e’=0 and if so, at step (604) determining no input to be provided for enabling an actuator (208). Further if at step (603), ‘e’=0 is not true, then at step (605), determining if ‘e’>0 and if Yes, then at step (606), providing brake control input to an actuator driver (207) for controlling one or more brakes of the vehicle (100) as indicated at step (607) to control the vehicle speed as indicated at step (609) which is fed to step (602). Further, if at step (605), ‘e’<0, then identifying no input to be provided to the actuator (208) as indicated at step (608).

It is to be understood that the aspects of the embodiments are not necessarily limited to the features described herein. Many modifications and variations of the present subject matter are possible in the light of above disclosure.

1-11. (canceled)

12. An electro-mechanical actuation control system for a vehicle, the electro-mechanical actuation control system comprising:
a comparator that is configured to compare a desired vehicular component data to an actual vehicular component data;
a controller that is configured to enable control of one or more vehicular components and includes one or more vehicle component controllers;
a transmitter that is configured to remotely transmit input signals to the vehicle, the input signals being generated by the controller;
a receiver that is configured to receive transmitted input signals from the controller and mounted on the vehicle;
an actuator driver that is configured to receive inputs from the receiver and mounted on the vehicle;
an actuator that is coupled to the actuator driver and configured to be operable in any one of an enabled state and a disabled state caused by the actuator driver; and
one or more vehicle components that comprise a drive unit of the vehicle, the drive unit including one of an engine assembly, an electric motor and a combination of the engine assembly and the electric motor, wherein
the actuator driver is configured to control the drive unit through the actuator for controlling a speed of the vehicle.

13. The electro-mechanical actuation control system as claimed in claim 12, wherein the transmitter is integrated with the controller.

14. The electro-mechanical actuation control system as claimed in claim 12, wherein the actuator driver is a direct current servo motor.

15. The electro-mechanical actuation control system as claimed in claim 12, wherein the actuator includes a mechanical cable connected between one or more vehicle brakes and the actuator driver.

16. The electro-mechanical actuation control system as claimed in claim 12, wherein the actuator includes a mechanical cable connected between a throttle control valve and the actuator driver.

17. The electro-mechanical actuation control system as claimed in claim 12, wherein the controller is powered by an auxiliary power source and the receiver is powered by another auxiliary power source.

18. The electro-mechanical actuation control system as claimed in claim 12, wherein
the controller includes a throttle valve controller, and
the one or more vehicle components include a throttle control valve connected to the actuator.

19. The electro-mechanical actuation control system as claimed in claim 12, wherein
the controller includes a vehicle brakes controller, and
the one or more vehicle components include one or more vehicle brakes connected to the actuator.

20. A method to control an electro-mechanical actuation control system for a vehicle, the method comprising the steps of:
initializing the electro-mechanical actuation control system;
comparing an actual vehicle component data received from the vehicle with a desired vehicle component data and determining a difference in the actual vehicle component data against the desired vehicle component data;
identifying the vehicle to be at desired vehicle component data upon no difference in the actual vehicle component data and the desired vehicle component data, and no input being sent to an actuator driver;
identifying the vehicle to be at difference vehicle component data upon receiving a difference in the desired vehicle component data and the actual vehicle component data;
enabling the actuator driver by receiving inputs from a controller;
enabling the actuator according to inputs received from the actuator driver;
controlling one or more vehicle components and a drive unit of the vehicle by the actuator driver; and
achieving a desired vehicle speed.

21. The method to control an electro-mechanical actuation control system as claimed in claim 20, wherein the method comprising the steps of:
providing a brake control input to the actuator driver upon the difference in speed data being greater than 0;
enabling brake control actuation of the actuator by the actuator driver;
controlling one or more brakes of the vehicle by enabling the actuator;
providing a throttle control input to the actuator driver upon the difference in speed data being not greater than 0;
enabling throttle control actuation of the actuator by the actuator driver;
controlling opening of a throttle valve by enabling the actuator to achieve the desired vehicle speed.

22. The method to control an electro-mechanical actuation control system as claimed in claim 20, wherein
the electro-mechanical actuation control system incorporates a failsafe method comprising steps of:
initializing the failsafe method;
monitoring for a throttle position input from a throttle position sensor;
identifying no inputs to be sent to the controller upon failure of the actuator being not determined;
identifying the sensor inputs to be sent to the controller upon failure of the actuator being determined;
transmitting activation signals wirelessly to one or more vehicle component controller; and
enabling vehicle speed control.
